(19) United States
(12) Patent Application Publication
(10) Pub. No.: US 2002/0040414 A1
(43) Pub. Date: Apr. 4, 2002

(54) Multiprocessor system and transaction control method for the same

(76) Inventors: Keitaro Uehara, Kokubunji (JP); Hideya Akashi, Kunitachi (JP); Yuji Tsushima, Kokubunji (JP)

Correspondence Address: REED SMITH HAZEL & THOMAS LLP, Suite 1400, 3110 Fairview Park Drive, Fall Church, VA, 22042, US

(21) Appl. No.: 09/897,053

(22) Filed: Jul. 3, 2001

(30) Foreign Application Priority Data
Sep. 29, 2000 (JP) 2000-302832

(51) Int. Cl. G06F 13/00

(52) U.S. Cl. 710/100

(57) ABSTRACT

A processor system and method whereby a successive transaction which depends upon a preceding transaction is sent without waiting for the completion of the preceding transaction issued from an I/O bus to a memory. A source side I/O unit consecutively issues transactions from an I/O bus. A reply side node controller unit or transfer unit has an I/O flag register for recording a reply-requested or reply-pending preceding transaction to assure transactions from the same I/O bus are sequentially completed according to certain bus protocols. Consequently, the reply side node controller unit or transfer unit retries or suspends the reply to the successive transaction, when retry of a preceding transaction is requested or its reply is suspended. Various internal registers and counters may be used.

### PRIORITY TO FOREIGN APPLICATIONS

This application claims priority to Japanese Patent Application No. P2000-302832.

### BACKGROUND OF THE INVENTION

1. Field of the Invention

The present invention relates to processor systems and methods for handling consecutive transaction issues, and more specifically relates to processor systems and methods which assure the completion order of consecutive transactions requested from a device on an I/O bus.

2. Description of the Background

Posted writing is one of the methods for processing write transactions issued from an I/O bus in a system. According to the posted writing method, a write transaction is completed in a source bus just after it is accepted by the system, and the system assures the processing of successive transactions. When a write transaction is issued from an I/O bus, the bus or processor is enabled to issue a successive transaction before the transaction is completed in the system, thereby the performance of the system may be improved.

However, the above method has sometimes been confronted with a problem in which the completion order of write transactions issued from a device on a PCI bus must be assured in accordance with the predefined rules (protocols, conditions) such as the PCI Local Bus Specification Revision 2.2. When a preceding transaction is retried and a successive transaction having dependency on the preceding one is issued thereafter, the successive transaction is typically completed before the preceding one, whereby the intended completion order of the transactions is violated. Herein, a “retry” means requesting a source device to make an access again (at a later time) after the initial access has been temporarily rejected. Consequently, when a PCI bus issues a write transaction to the system, the PCI bus suppresses issuing of successive transactions until the completion of the writing is assured without retry, thereby satisfying the rules or conditions.

According to the above conventional method, in the case where a PCI bus issues consecutive transactions that depend on each other, the successive transactions cannot be issued until completion of the preceding transaction has been assured. Consequently, the performance of the system may be degraded which is a potential problem for a processor system.

In the case of a multiplexed multiprocessor system in which many nodes are connected to each another via a network, many snoop transactions are issued from those nodes. The total performance of the system may be degraded by an increase of the snoop throughput of the processor bus. To address this problem, the system may be configured so that, for example, each node controller unit filters snoop transactions so as to issue those snoop transactions onto the processor bus only as needed. When the system is configured in this way, each reply side node controller unit will not reply to every received transaction in the requested order (i.e., in the order the requests were made). When a reply to a preceding transaction is suspended in a system in which the completion order of transactions issued by the same PCI bus is to be assured, all of the successive transactions must be retried by giving consideration to the retry possibility.

Each reply side node controller unit may be provided with a bit map covering all of the source devices in the system to assure the completion order of transactions. The number of bit maps employed in the system is proportional to both the total number of I/O buses and the total number of node controllers in the system. Consequently, the number of I/O buses is proportional to the number of nodes, and the total number of bit maps increases in proportion to the square of the number of nodes. Therefore an increase in the number of bit maps may cause a problem in a system having many nodes.

### SUMMARY OF THE INVENTION

In at least one preferred embodiment, the present invention preferably provides a processor system provided with a node controller unit connected to one or more processors via a processor bus; one or more I/O units each having an I/O bus; and one or more memories connected to these components via a network. The processor system is capable of transferring a transaction issued from any one of the I/O buses (sources) in a given node to the processor in any one of the nodes or any one of the target memories via the network. The processor system may also have one or more of the following functions used to address the problems described above.

The I/O unit preferably issues consecutive transactions to any one of the memories and/or the processors regardless of whether a preceding transaction is completed or not. The node controller unit replies to each of these requested transactions in a given order. The node controller unit, when the memory or processor retries a preceding transaction or suspends the reply to the preceding transaction issued from the same I/O bus, preferably causes the I/O unit to suspend the reply to the successive transaction or reissues a retry-requested transaction, thereby assuring the completion order of the issued transactions.

Additionally, the node controller unit preferably includes a retry control register and a reply pending control register. The retry control register has retry bits corresponding to the number of I/O buses. Each of the retry bits records a preceding retry-requested transaction issued from the I/O bus. The reply pending control register has pending bits corresponding to the number of I/O buses. Each of the pending bits records a pending reply to a preceding transaction issued from the I/O bus.

The node controller unit or the transfer unit preferably includes the ability to set a corresponding retry bit in the retry control register when retrying a write transaction issued from the I/O unit and to enable the successive transaction to be retried when said retry bit is set. The I/O unit has a transaction queue for storing transactions issued from the I/O buses sequentially and a transaction attribute field for checking whether the transaction is a retried one (whether the transaction has been retried). The I/O unit may also include the functionality for consecutively issuing transactions from the transaction queue and a function for reissuing retry-requested transactions.

The I/O unit also has a function for adding a header flag to the first transaction in the transaction queue so as to distinguish it from successive transactions when issuing transactions consecutively or reissuing transactions. The node controller unit or the transfer unit has a function for clearing the retry control register when receiving the first transaction.

Additionally, the I/O unit may be capable of adding the same ID as that added to a transaction previously when it is issued in order to reissue a retry-requested transaction from the transaction queue. The node controller unit or the transfer unit preferably has a transaction ID field together with the retry bits corresponding to the number of the I/O buses in the retry control register, as well as a function for setting a corresponding retry bit to a write transaction issued from the I/O unit and recording the ID of the retry-requested write transaction in the transaction ID field. The node controller unit or the transfer unit also has a function for clearing the retry bit when the ID of the transaction matches with that recorded in the transaction ID field as a result of reference to the transaction ID field in the retry control register when accepting the write transaction reissued from the I/O unit.

Additionally, the I/O unit may have a retry counter for denoting the number of retry-requested transactions to be reissued, a function for adding the value of the retry counter to each transaction issued from the transaction queue consecutively, and a function for incrementing the value of the retry counter by one each time a transaction is reissued therefrom. The node controller unit or the transfer unit has a retry counter field for recording the value of the transaction retry counter together with the retry bits corresponding to the number of the I/O buses in the retry control register, as well as a function for setting the corresponding bit and recording the value of the transaction retry counter in the retry counter field when a write transaction issued from the I/O unit is to be retried. The node controller unit or transfer unit may also have a function for referring to the corresponding retry counter field in the I/O flag register when accepting a transaction issued from the I/O unit and a function for clearing the retry bit when the value in the retry counter field does not match with the value in the transaction retry counter.

The node controller unit has a function for suspending a reply to a transaction during the time in which it is impossible for the processor to reply to the transaction and a function for replying to a successive transaction while the reply to the preceding transaction is suspended. The node controller unit or the transfer unit may also be capable of setting a pending bit in the reply pending control register, corresponding to the I/O bus when suspending the reply to a received transaction temporarily.

The node controller unit or the transfer unit has a function for retrying a successive transaction when the pending bit corresponding to the I/O bus in the reply pending control register is set and a function for clearing the pending bit when replying to the suspended transaction. The node controller unit or the transfer unit may also be capable of suspending a reply to a successive transaction when the pending bit corresponding to the I/O bus in the reply pending control register is set and clearing the pending bit when the unit clears the retry bit corresponding to the I/O bus in the retry control register.

The node controller unit or the transfer unit may have a pending counter instead of the pending bit corresponding to the I/O bus in the reply pending control register, the functionality to increment the value of the pending counter by one each time a reply to a transaction issued from the I/O unit is suspended, the functionality to suspend the reply to the transaction when accepting a successive transaction issued from the I/O unit while the value in the corresponding pending counter is at least “1,” and the functionality for decrementing the value of the pending counter by one each time it replies to a reply-suspended transaction.

The node controller unit or the transfer unit preferably has pending bits corresponding to the number of I/O buses in the reply pending control register and pending ID fields corresponding to the number of I/O buses in the reply pending control register. The node controller unit or the transfer unit may record the ID of a transaction issued from the I/O unit in the pending ID field when the reply to the transaction is suspended and may refer to the corresponding pending ID field and clear the corresponding pending bit when the ID in the corresponding pending ID field in the reply pending control register matches with the ID of the transaction when replying to a reply-suspended transaction.

The node controller unit or the transfer unit has I/O queues corresponding to the number of I/O buses, the ability to store transactions issued from the I/O unit in the order they are accepted by the corresponding I/O queue and the ability to suspend a reply to a transaction when replying to the transaction issued from the I/O unit in the case where the transaction is not the first entry of the corresponding I/O queue.

These and other potential objects, features and/or advantages of the invention will appear more fully from the following detailed description of the invention, the drawings, and the attached claims.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a block diagram of a processor system according to a first exemplary embodiment of the present invention;

FIG. 2 is a concept illustration of a header flag field;

FIG. 3 is a concept illustration of a transaction ID field to be added to a transaction;

FIG. 4 is a concept illustration of a retry counter field to be added to a transaction;

FIG. 5 is a concept illustration of a retry counter provided in an I/O transaction sending unit; and

FIG. 6 is a block diagram of a processor system according to a second exemplary embodiment of the present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided hereinbelow with reference to the attached drawings.

[First Exemplary Embodiment]

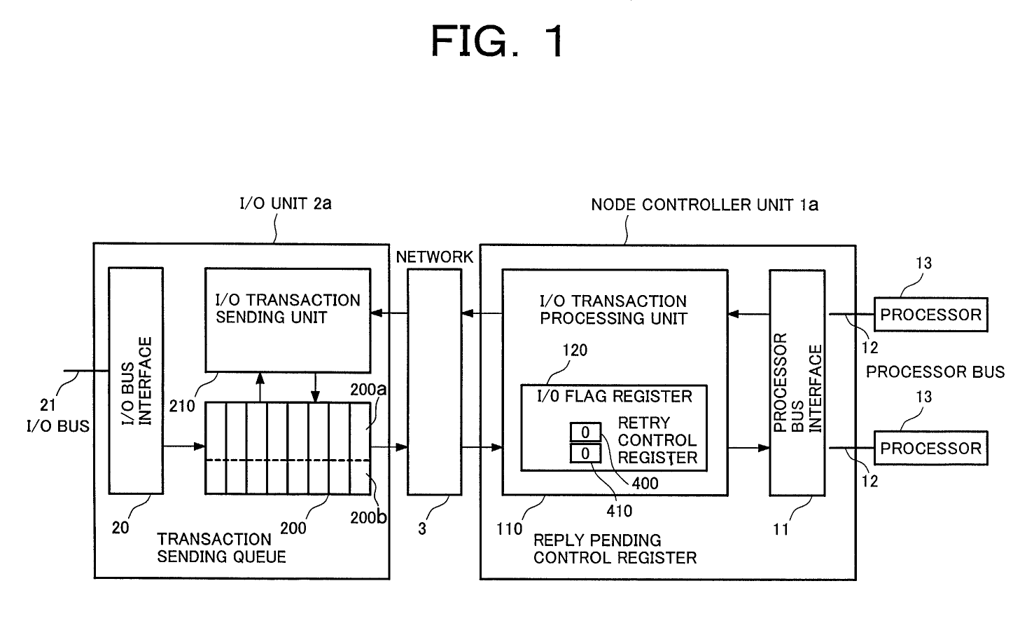

Hereunder, a first exemplary embodiment of the present invention will be described with reference to FIGS. 1 through 5 in which the present invention is applied to consecutive write transactions issued from an I/O bus to a memory.

FIG. 1 is a schematic block diagram of a processor system according to a first exemplary embodiment of the present invention. The processor system is configured by a node composed of a node controller 1a or I/O unit 2a, as well as a memory (not shown). One or more nodes and one or more memories are preferably connected to each other through a network 3. In FIG. 1, the I/O unit 2a belongs to a different node from that of the node controller 1a, but it may (in some embodiments) belong to the same node as that of the node controller 1a. The following description will thus not distinguish between those configurations.

The I/O unit 2a preferably includes an I/O bus interface 20 having an interface with one or more I/O buses 21a; a transaction sending queue 200 for storing transactions issued from those I/O buses 21a; and an I/O transaction sending unit 210 that controls the transactions stored in the transaction queue 200. Each entry of the transaction sending queue 200 may include fields 200a for storing transactions and transaction attribute fields 200b for identifying whether each transaction is retried by the node controller unit 1a.

The node controller unit 1a preferably includes a processor bus interface 11 having an interface with each processor bus 12 connected to one or more processors 13; an I/O transaction processing unit 110 for controlling transactions issued from the I/O unit 2a; and an I/O flag register 120. The I/O flag register 120 is configured by two registers (a retry control register 400 and a reply pending control register 410). The details of each register will be described below.

A description will now be made for a write transaction issued from a device on an I/O bus to a memory. The write transaction is issued from a device on the I/O bus 21 and written in a memory. At this time, a processor 13 often has the same data in its cache, so the device issues a cache coherency control transaction to the node controller unit 1a via the processor bus interface 11. The transaction is completed when the coherence control is ended. According to PCI bus and other standards, the write transactions issued from an I/O bus to a memory must be completed in the same order in which they are issued from a device on the I/O bus 21. In order to improve the bus throughput, transactions should be issued consecutively (one after another) while the completion order is assured.

The reply side processor bus interface 11 replies to those cache coherency transactions in one of three ways according to the state of the cache of the subject processor 13.

1. When the subject data is not found in the cache of the processor 13, the write transaction to the memory can be executed immediately. An “ok” is thus replied.

2. When it is impossible to execute a write transaction to the memory, a retry is requested.

3. When it is expected that the subject data is in the cache of the processor 13, the processor bus interface 11 requests the processor 13 to invalidate the data. In this case, the reply from the processor 13 determines whether “ok” or “retry,” so the processor bus interface 11 suspends the reply once until the processor 13 replies.

In order to maintain the order in which the transactions have been issued according to the processor reply conditions listed above, at least one presently preferred embodiment of the invention utilizes the following processing procedure.

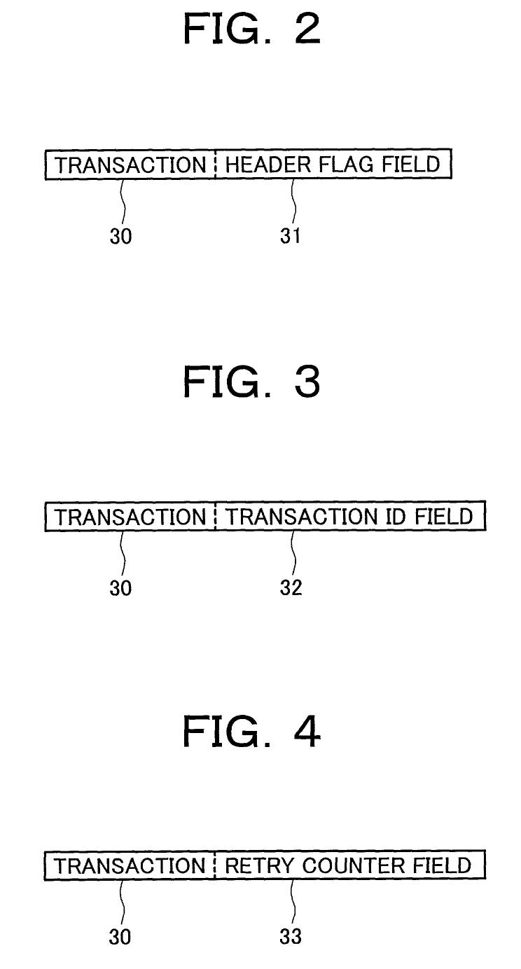

(1) The request source side I/O unit 2a issues consecutive transactions to the node controller unit 1a including the processor 13, with a condition that the requests be completed in the order they are sent. At this time, a value ‘1’ is set in the header flag of the first transaction among the series of transactions issued from the same I/O bus 21a. The value ‘1’ denotes that the transaction 30 is the first one as shown in FIG. 2.

(2) Receiving a transaction, the node controller unit 1a requests retry of the successive transaction(s) when retry of the preceding transaction is requested.

(3) The I/O unit 2a reissues retry-requested transactions in the correct order (in the original order). At this time, a value ‘1’ is set in the header flag 31 of the first of the reissued transactions because it is now the first in the series of transactions.

(4) When the node controller unit 1a suspends a reply to a preceding write transaction, the unit 1a also suspends the reply to successive transaction(s) and decides whether to retry them according to the processing result of the preceding transaction.

The present invention preferably assures the completion order of successive transactions by improving the throughput of consecutively issued transactions in (1), and retrying and reissuing transactions in (2) and (3). In addition, the present invention may also assure the completion order of transactions even when a reply to a transaction is suspended.

An example of this embodiment will now be described in detail. At first, it is assumed that each unit performs the following operation(s) so as to realize the processing procedure described above.

(Source Side Unit Operation)

(1) Transactions issued from the I/O bus 21a to the I/O bus unit 2a are stored sequentially in the transaction sending queue 200. Each entry of the transaction sending queue 200 has a transaction attribute field 200b in which a ‘0’ is set for a transaction that has not yet been issued and a ‘1’ is set for a retry-requested transaction.

(2) The I/O transaction sending unit 210 issues transactions stored in the transaction sending queue 200 sequentially and consecutively. At this time, the transaction 30 and the header flag 31 are added to the first transaction among the series of the transactions issued from the same I/O bus 21a as shown in FIG. 2. The header flag 31 denotes that the subject transaction is the first one.

(3) The I/O transaction sending unit 210 receives a reply to each transaction issued therefrom. When receiving an “ok” from the node controller unit 1a, the I/O transaction sending unit 210 deletes the entry of the corresponding transaction from the transaction sending queue 200 (it will not need to be resent).

(4) When receiving a retry request for a transaction from the node controller unit 1a, the I/O transaction sending unit 210 sets ‘1’ in the transaction attribute field 200b of the corresponding entry in the transaction sending queue 200 indicating that it should be reissued.

When reissuing the retry-requested transactions, the header flag 31 is added to the first reissued transaction.

More specifically, the I/O transaction sending unit 210 has a function (1) for consecutively issuing transactions from the transaction queue and a function (2) for adding a header flag to the first transaction among the consecutive transactions.

(Reply Side Unit Configuration)

The details of the reply side unit configuration will now given. The I/O flag register 120 has a retry control register 400 and a reply pending control register 410 therein. Each of the registers 400 and 410 has an entry corresponding to each of the I/O buses 21a in the processor system. In each entry of the retry control register 400, a retry bit ‘0’ is preferably set as the initial value (because nothing has been retried). The retry bit records whether or not a transaction issued from any of the corresponding I/O buses 21a is retried.

In each entry of the reply pending control register 410, a pending bit is preferably set to ‘0’ as the initial value. The pending bit records whether or not the reply to the subject transaction issued from any of the I/O buses 21a is suspended. The configurations of the retry control register 400 and the reply pending control register 410 may be modified as indicated further below in this description.

(Reply Side Unit Operation)

(1) The I/O transaction processing unit 110, when receiving a transaction, initially checks whether or not a header flag 31 is added to the transaction. When the header flag 31 is added, the I/O transaction processing unit 110 in the retry control register of the I/O flag register 120 clears the retry bit corresponding to the source unit to ‘0’.

(2) The I/O transaction processing unit 110 refers to the retry bit and the pending bit corresponding to the source I/O bus 21a. The retry bit and the pending bit are provided as part of the flag register 120 in the retry control register 400 and the reply pending control register 410 respectively.

(a) When a ‘1’ is set in the corresponding retry bit in the retry control register 400, it denotes that the preceding transaction is retried. When the retry bit is ‘1’, the I/O transaction processing unit 110 requests retry of the transaction.

(b) When a ‘0’ is set in the corresponding retry bit in the retry control register 400 and a ‘1’ is set in the corresponding pending bit in the reply pending control register 410, it denotes that the reply to the preceding transaction has been suspended. In this case, because the preceding transaction is expected to be retried, the I/O transaction processing unit 110 requests retry of the accepted transaction(s) so as to assure the completion order, then sets ‘1’ in the corresponding retry bit.

(c) When a ‘0’ is set both in the corresponding retry bit of the retry control register 400 and in the corresponding pending bit of the reply pending control register 410, the operation of the I/O transaction processing unit 110 is decided by whether or not the processor bus interface 11 accepts the transaction.

(1) When the processor bus interface 11 requests a retry of a transaction, the I/O transaction processing unit 110 requests the retry to the source I/O unit 2a and then sets a ‘1’ in the corresponding retry bit.

(2) When the processor bus interface 11 is able to accept a request, the I/O transaction processing unit 110 returns an “ok” reply to the source I/O unit 2a.

(3) When the processor bus interface 11 is unable to reply to a transaction immediately (e.g., the processor bus is busy), the I/O transaction processing unit 110 preferably suspends the reply to the transaction. At this time, the I/O transaction processing unit 110 sets a ‘1’ in the corresponding pending bit in the reply pending control register 410.

(3) When the processor bus interface 11 returns a “suspended” reply to a transaction, the I/O transaction processing unit 110 clears the pending bit to ‘0’ so as to reset the pending state.

(a) When a transaction is to be retried as a result of a cache coherency control request issued to the processor 13, the I/O transaction processing unit 110 preferably requests a retry of the transaction to the source I/O unit 2a and then sets a ‘1’ in the corresponding retry bit of the retry control register 400.

(b) When the processor 13 ends the cache coherency control, the I/O transaction processing unit 110 returns an “ok” reply to the source I/O unit 2a.

More specifically, the reply side unit is preferably capable of (1) assuring the completion order by retrying the successive transaction(s) when the preceding transaction is retried or expected to be retried and (2) clearing the retry flag so as to restart the processing when receiving a transaction to which the header flag is added.

The operation of the complete system will now be described in detail utilizing examples in which a transaction is to be retried and one in which the reply to a transaction is to be suspended respectively. Initially, a description will be made for a method for assuring the completion order of transactions when a retry is requested to the transaction Tb while a series of transactions Ta to Tc are issued consecutively.

Transactions Ta to Tc are issued from a device on an I/O bus 21a to a node 1a. The issued transactions Ta, Tb, and Tc are stored sequentially in the transaction fields 200a of the transaction queue 200. The transaction attribute field 200b is set to ‘0’ denoting that the subject transaction is requested for the first time. Then, the I/O transaction sending unit 210 issues a transaction to the destination node 1a via the network 3. At this time, the I/O transaction sending unit 210 adds a header flag field 31 to the Ta transaction 30 (as shown in FIG. 1) because Ta is the first transaction among the series of transactions.

A description will now be made for the operation of the target node in response to a received transaction. The target node controller unit 1a preferably processes transactions received by the I/O transaction processing unit 110 sequentially. At this time, a ‘0’ is set in the corresponding retry bit of the retry control register 400 in the I/O flag register 120. The value ‘0’ denotes that the preceding transaction has not been retried. The I/O transaction processing unit 110 thus completes the transaction Ta and returns an “ok” reply to the source node 2a to report the normal acceptance of the transaction processing.

The I/O transaction processing unit 110 also receives the transaction Tb, but the processor bus interface 11 cannot process the transaction Tb because it is busy processing Ta. The I/O transaction processing unit 110 preferably requests the source node 2a for a retry of the transaction Tb. At this time, the I/O transaction processing unit 110 sets a ‘1’ in the corresponding retry bit of the retry control register 400.

Upon thereafter sequentially receiving the transaction Tc, the I/O transaction processing unit 110 preferably also requests the source node 2a for a retry of the transaction Tc because ‘1’ is set in the corresponding retry bit of the retry control register 400 (set above).

The source node I/O unit 2a deletes the entry of the transaction Ta from the transaction sending queue 200 because the unit 2a has already received an “ok” for the transaction Ta from the node controller unit 1a. As for the transactions Tb and Tc, however, the unit 2a is requested to retry them respectively from the node controller unit 1a. Thereby, a ‘1’ is preferably set in the transaction attribute field denoting that each transaction has been requested to be retried. The I/O transaction sending unit 210 thus reissues the transactions in response to the retry requests. Because the transaction Tb is sent first at this time (Ta is not being resent), a header flag 31 is added to the transaction Tb.

Because a header flag is added to the received transaction Tb and a ‘1’ is set in the corresponding retry bit in the retry control register 400, the node controller unit 1a knows that the transaction Tb is the first one among the series of reissued transactions to be received. As a result, the I/O transaction processing unit 110 clears the corresponding retry bit in the retry control register 400 to ‘0’, then restarts the processing of the transactions Tb and Tc.

Utilizing the above processing method, when a transaction issued from the I/O bus 21a is retried, the node controller unit 1a can retry the processing of the successive transactions, whereby the completion order of transactions can be assured.

Next, a description will be made for the operation of the node controller unit 1a for coping with pending of a reply to a transaction. When a series of transactions Ta to Tc are issued consecutively and the reply to Tb is suspended, the completion order of transactions is preferably assured as follows.

The I/O transaction processing unit 110 that has received the transaction Tb, when the processor bus interface 11 cannot reply to the transaction Tb immediately (e.g., because it is busy processing Ta), preferably suspends the reply. At this time, the I/O transaction processing unit 110 sets a ‘1’ in the pending bit corresponding to the source I/O bus. The pending bit is in the reply pending control register 410 of the I/O flag register 120. The processor bus interface 11 then waits for a reply to the transaction Tb.

The I/O transaction processing unit 110, when the successive transaction Tc arrives while ‘1’ is set in the corresponding pending bit in the reply pending control register 410, preferably attempts to retry the transaction Tc so as to keep the completion order of transactions, since it is expected that the transaction Tb will be retried. Therefore, the I/O transaction processing unit 110 sets a ‘1’ in the corresponding retry bit in the retry control register 400.

At this time, the processor bus interface 11 can execute cache coherency controlling for the Tc if possible, although the Tc must be retried so as to keep the completion order of transactions. Because this completion order must be kept on the I/O bus 21a, no problem occurs from execution of the cache coherency control at any timing. Thus, the I/O transaction processing unit 110 preferably queries the processor bus interface 11 about the capability of processing the transaction Tc. When the processor bus interface 11 cannot reply to the Tc immediately, the I/O transaction processing unit 110 preferably suspends the reply, then determines whether to retry the transaction Tc. When the processor bus interface 11 can reply to the Tc immediately, the I/O transaction processing unit 110 requests the source I/O unit 2a for retry of the Tc immediately, regardless of the result (ok or retry).

Receiving the reply of the processor bus interface 11 to the Tb, the I/O transaction processing unit 110 recognizes that the reply to the transaction Tb has been suspended and clears the corresponding pending bit in the reply pending control register 410 to ‘0’.

With the above processing method, the completion order of transactions is preferably assured even when a reply to a transaction is suspended while a series of transactions is issued consecutively. Where this method is employed and a successive transaction arrives while the reply to the preceding transaction is suspended, the successive transactions are all to be retried. When the processor bus interface 11 replies to the preceding transaction before the successive transaction arrives, however, the method enables the processing of the successive transactions to be continued according to normal processing procedures.

With the above processing method, therefore, when a transaction from an I/O bus is retried even after the reply to the transaction is suspended, the successive transactions can be retried, whereby the completion order of transactions can be assured.

In the case of the processor system in this embodiment, only a source node executes the cache coherency control. While all the nodes may snoop a cache coherency control transaction, any node can control the retries of transactions by adding a control that enables such retries only when all the node controller units that have issued requests reply “ok” respectively.

[Additional Variation of the First Exemplary Embodiment]

A variation of the above first embodiment provides another method for enabling the I/O transaction processing unit 110 to suspend a reply to the transaction Tc that arrives, without requesting a retry while the preceding transaction is suspended. In this case, the I/O transaction processing unit 110 suspends the replay to the transaction Tc until it receives the reply to the suspended transaction (Tb in the present example) even when the processor bus interface 11 replies to the Tc immediately. When the processor bus interface 11 replies “ok” to the Tb, the I/O transaction processing unit 110 preferably replies “ok” to the Tc (when the reply to the Tc is retry, the retry proceeds normally).

When this method is employed, unnecessarily long retries of a transaction may be avoided as long as the retry is actually requested for a transaction even when a successive transaction arrives while the reply to the transaction is suspended. However, because the corresponding pending bit in the reply pending control register 410 has only one bit, it may be impossible to know the number of transactions to which replies are suspended. Consequently, when the reply to only a transaction is suspended and the pending bit is set, this pending bit cannot be cleared when the pending is reset. In the above example, the reply to the Tc may already be suspended when the suspended reply to the Tb is returned. When a ‘0’ is set in the pending bit for the Tb at this time, it may lead to an incorrect recognition that no unit suspends the reply to a transaction Td that arrives later while the reply to the Tc is suspended. The pending bit, when it is set once, is cleared together with the retry flag in the retry control register 400 when the I/O transaction processing unit 110 receives the first transaction to which a header flag 31 is added.

[Additional Variation of the First Exemplary Embodiment]

In the above embodiment, the I/O unit 2a adds a header flag 31 to a retry-requested and reissued transaction, thereby communicating the state of the transaction to the node controller unit 1a. The node controller unit 1a thus clears the retry control register 400. In addition to the method that adds a header flag 31 to a transaction 30 in a way so as to communicate a reissued transaction from the I/O unit 2a to the node controller unit 1a, there may be additional methods to accomplish similar purposes.

One such method issues a transaction by assigning a specific ID to the transaction and reissuing the transaction using the same ID. According to this method, an ID 32 is preferably added to each transaction 31 before it is issued (instead of a header flag) as shown in FIG. 3. The retry control register 400 of the I/O flag register 120 in the node controller unit 1a has a retry ID field for recording the ID 32 of the retried first transaction. The retry ID field records the ID 32 of the retried first transaction when a ‘0’ is set in the retry flag. The I/O transaction sending unit 210 reissues a retry-requested transaction by adding the same ID as that added when the transaction is issued.

The I/O transaction processing unit 110, when accepting a transaction issued from an I/O bus, compares the ID in the retry ID field of the corresponding entry of the retry control register 400 with the ID 32 of the accepted transaction. When both IDs match, the node controller unit 1a regards the retried first transaction to be reissued and sets a ‘0’ in the corresponding retry flag.

[Additional Variation of the First Exemplary Embodiment]

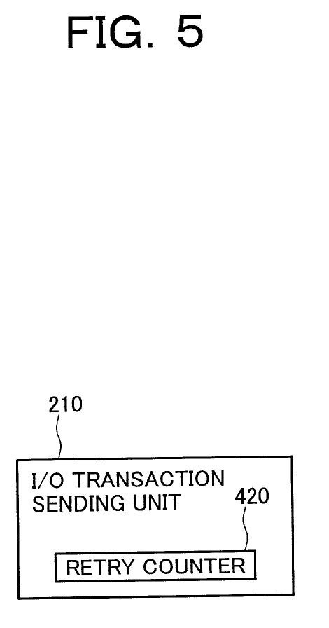

Instead of the method that uses the header flag employed in the above first embodiment, still another method uses a retry counter for denoting the number of retries. According to this method, the I/O transaction sending unit 210 has a retry counter 420 used to denote the number of retries for a transaction as shown in FIG. 5. As shown in FIG. 4, the I/O transaction sending unit 210 adds a retry counter field 33 to the transaction format 30. When issuing a series of transactions, the I/O transaction sending unit 210 adds the value of the same retry counter 420 to all the issued transactions. When retrying and reissuing a transaction, the I/O transaction sending unit 210 increases the value of the retry counter 420 by one and adds the new value to a series of transactions to be issued.

The node controller unit 1a includes a plurality of retry counter fields corresponding to the number of source I/O buses 21 in the retry control register 400 of the I/O flag register 120. Each retry counter field records the retry counter value 33 of a retried transaction. When a transaction is to be retried, the retry counter value 33 of the transaction is recorded in the retry counter field corresponding to the source I/O bus 21. The I/O transaction processing unit 110, when accepting a transaction issued from an I/O bus 21, compares the value of the corresponding retry counter in the retry control register 400 with the value of the retry counter 33 of the accepted transaction. When both values differ from each other, the node controller unit 1a regards the transaction as a reissued one, then sets a ‘0’ in the corresponding retry flag.

[Additional Variation of the First Exemplary Embodiment]

The pending bit may be replaced with a pending counter in the configuration of the reply pending control register 410 in the above first embodiment. In that case, the reply control register 410 functions as follows.

When the reply to the Tb is to be suspended, the I/O transaction processing unit 110 increments the value of the corresponding pending counter in the I/O flag register 120 by one. Specifically, the I/O transaction processing unit 110 sets a ‘1’ in the counter.

When a successive transaction Tc arrives while the value of the pending counter is 1 or higher (‘1’ in this case), the I/O transaction processing unit 110 preferably suspends the reply to this Tc unconditionally. Then, the I/O transaction processing unit 110 increments the value of the corresponding pending counter in the I/O flag register 120 by one. Specifically, the value of the counter becomes ‘2’.

When replying to the Tb, the I/O transaction processing unit 110 decreases the value of the corresponding pending counter in the I/O flag register 120 by one (decrements). Specifically, the value of the pending counter now becomes ‘1’.

The I/O transaction processing unit 110, after replaying to the Tb, can also know the capability for replying to the Tc. At this time, the I/O transaction processing unit 110 decreases the value of the corresponding pending counter in the I/O flag register 120 by one. Specifically, the value of the pending counter becomes ‘0’.

[Additional Variation of the First Exemplary Embodiment]

In addition to the pending bit, the configuration of the reply pending control register 410 in the above first embodiment may include a pending ID field. This field preferably records the ID of the last transaction to which the reply has been suspended. In this case, the I/O transaction processing unit 110 functions as follows.

When suspending the reply to the Tb, the I/O transaction processing unit 110 sets the corresponding pending bit in the I/O flag register 120. Specifically, a ‘1’ is set in the pending bit. At the same time, the Tb transaction ID 32 is set in the corresponding pending ID field.

When the successive transaction Tc arrives while a ‘0’ is set in the pending bit, the I/O transaction processing unit 110 suspends the reply to this Tc unconditionally. Then, the I/O transaction processing unit 110 overwrites the transaction ID 32 of the Tc in the pending ID field.

When replying to the Tb, the I/O transaction processing unit 110 compares the ID set in the pending ID field with the ID 32 of the transaction Tb. In this case, the ID of the transaction Tc is set in the pending ID field.

Because the IDs do not match, the I/O transaction processing unit 110 preferably executes no operation.

When replying to the Tc, the I/O transaction processing unit 110 also compares the ID set in the pending ID field with the ID of the transaction Tc. Because the IDs match at this time, the I/O transaction processing unit 110 clears the pending bit to a ‘’.

[Second Exemplary Embodiment]

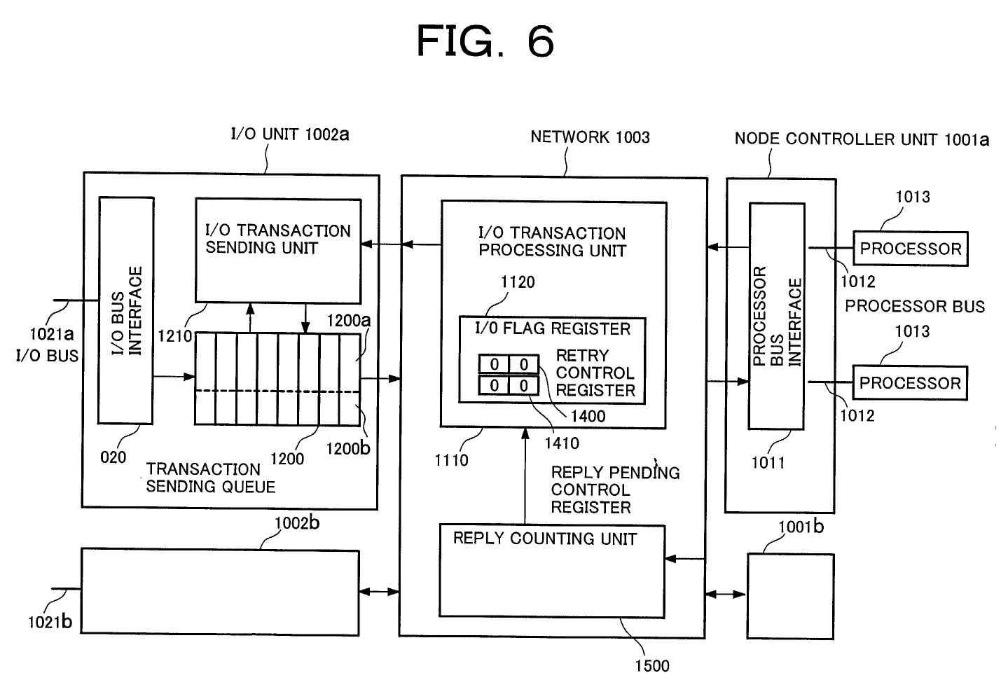

Additional embodiments of the present invention will now be described with reference to FIG. 6. FIG. 6 is a schematic block diagram of a processor system according to the present exemplary embodiment. The system is configured by a node including node controller units 1001a and 1001b or I/O units 1002a and 1002b, as well as a memory (not shown). The node and the memory are connected to each other via a network 1003 (e.g., multiplexing the system). In FIG. 8, the I/O units 1002a and 1002b belong to a different node from that of the I/O units 1002a and 1002b. They may, however, belong to the same node. The following description does not therefore distinguish between these two cases.

The I/O units 1002a and 1002b are the same as the I/O units 2a shown in the first exemplary embodiment shown in FIG. 1. Each of the node controller units 1001a and 1001b has a processor bus interface 1011 including an interface with the processor bus 1012 connected to one or more processors 1013.

The network 1003 (or any transfer unit on the route) preferably has an I/O transaction processing unit 1110 for controlling transactions issued from the I/O units 1002a and 1002b and an I/O flag register 1120 therein. The I/O flag register 1120 is configured by two registers: a retry control register 1400 and a reply pending control register 1410. The details of each of the registers will be described below. The network 1003 also has a reply counting unit 1500 for counting the number of replies from the node controller units 1001a and 1001b.

A description will be now made briefly of a write transaction issued from a device on an I/O bus to a memory. The write transaction is issued from a device on an I/O bus 1021a and written in the memory. At this time, the processor 1013, because the same data might be in the cache, issues a transaction for cache coherency control to all the node controller units 1001a and 1001b in the system via the processor bus interface 1011 and completes the transaction when the coherency control is ended. These write transactions issued from an I/O bus to the memory must be completed in the same order that they are issued from the I/O bus 1021 (as with a PCI bus). In order to improve the bus throughput at this time, these transactions must be issued consecutively while the completion order of them is assured.

The reply side processor bus interface 1011 preferably replies in the following three ways according to the state of the cache of the processor 1013.

1. When no data is in the cache of the processor 1013, the processor bus interface 1011 replies “ok” because it can process the write transaction to the memory immediately.

2. When the write transaction to the memory can not be processed immediately, the processor bus interface 1011 requests retry of the transaction.

3. When the data might possibly be in the cache of the processor 1013, the processor bus interface 1011 requests the processor 1013 to invalidate the data. In this case, the processor bus interface 1011 determines whether to reply “ok” or to request a retry according to the reply from the processor 1013. The processor bus interface 1011 thus suspends the reply until it receives the reply from the processor 1013.

In order to maintain the order that transactions are issued according to the above processor conditions, this second embodiment preferably utilizes the following processing procedure. First, the source side I/O unit 1002a issues transactions consecutively to all the node controller units 1001a and 1001b including the target processor 1013 in the correct order. At this time, in order to denote the first transaction among the series of transactions issued from the same I/O bus 1021a, a ‘1’ is set in the header flag 31 of the first transaction 30 as shown in FIG. 2.

The network 1003 transfers the issued I/O transactions to the target node controller units 1001a and 1001b. The reply counting unit 1500 of the network 1003 preferably counts the number of replies from the node controller units 1001a and 1001b and communicates the reply count to the I/O transaction processing unit 1110. The reply counting unit 1500, when a reply from a node controller unit 1001a/1001b is to retry a transaction, counts the result as a retry.

The I/O transaction processing unit 1110 manages the I/O flag register having registers corresponding to the source I/O buses 1021a and 1021b. When a preceding write transaction is requested to be retried, the I/O transaction processing unit 1110 requests retry of the successive transaction(s). The I/O transaction processing unit 1110 thus returns the final result to the source I/O unit 1002a.

The I/O unit 1002a reissues the retry-requested transactions in the order they are issued. At this time, the I/O unit 1002a sets a ‘1’ in the header flag of the first transaction among those reissued ones (which is now the first transaction in the series to be transmitted).

When the processor bus interface suspends the reply to a transaction, the node controller unit 1001a/1001b communicates the pending reply to the reply counting unit 1500 of the network 1003. The reply counting unit 1500 communicates the result to the I/O transaction processing unit 1110 each time a pending reply is returned to a transaction. The I/O transaction processing unit 1110 can change the reply order of the transactions issued from different source units as needed so as to reply to those source units.

When the reply to a preceding write transaction issued from the same source bus 1021a is suspended, the reply counting unit 1500 communicates this to the I/O transaction processing unit 1110 and suspends the reply to the successive transaction(s) issued from the same source bus 1021a. The I/O transaction processing unit 1110 decides whether to retry the successive transaction according to the result of the preceding transaction processing.

In a sense, this second exemplary embodiment can be regarded as an example in which the function of the I/O transaction processing unit 1110 in the first exemplary embodiment is shifted from the node controller unit to the network. Specifically, the node controller, when it does not have to assure the completion order, enables replies to be processed in the network so as to assure the order transactions are retried and their replies are suspended. The section of the network that includes the transaction processing unit is referred to herein as the “transfer unit.” It may be located at various locations in the network.

Various examples of the second exemplary embodiment will now be described in detail. At first, a description will be made for each unit operation in the procedure described above.

(Source Unit Operation)

In FIG. 6, the reference numbers in the first embodiment shown in FIG. 1 are changed as follows. The operation of each unit is substantially the same between FIGS. 1 and 6.

I/O bus 1021a→I/O bus 21

I/O bus unit 1002→I/O bus unit 2a

Transaction sending queue 1200→transaction sending queue 200

Transaction attribute field 1200b→transaction attribute field 200b

I/O transaction sending unit 1210→I/O transaction sending unit 210

(Transfer Unit Configuration)

In FIG. 6, the reference numbers are changed as follows from those shown in FIG. 1. In FIG. 6, a reply counting unit 1500 is added to the reply side unit configuration in the first exemplary embodiment shown in FIG. 1.

I/O flag register 1120→I/O flag register 120

Retry control register 140043 Retry control register 400

Reply pending control register 1410→Retry control register 410

(Transfer Unit Operation)

The following reply counting processing is added to the reply side unit operation in the first embodiment.

(1) The network 1003 transfers transactions issued from the I/O unit 1002a to all the node controller units 1001a and 1001b.

(2) The reply counting unit 1500, when receiving replies from all the node controller units 1001a and 1001b that have issued transactions, communicates the reply count to the I/O transaction processing unit 1110. The I/O transaction processing unit 1110 then refers to the I/O flag register 1120 and returns the final reply to the source I/O unit 1002a. Specifically, the reply is returned as follows at this time.

(a) When a reply from a node controller unit 1001a is suspended, the result is suspended until the replies from all the node controller units 1001a and 1001b are returned.

(b) The I/O transaction processing unit 1110 replies a retry request when receiving replies from all the node controller units 1001a and 1001b and the reply from at least one such node controller unit 1001a is a retry request or when the preceding transaction issued from the same I/O bus 1021a is to be retried or when the reply to the transaction is suspended.

(c) When receiving “ok” replies from all the node controller units 1001a and 1001b and the preceding transaction issued from the same I/O bus 1021a is not to be retried and the reply to the transaction is not suspended, the I/O transaction processing unit 1110 replies “ok”.

(3) The I/O transaction processing unit 1110 has an I/O flag register 1120 for recording retry or reply pending of each transaction issued from the same I/O bus 1021a. The operation and function of the I/O flag register 1120 is the same as that of the I/O flag register described above.

(4) The I/O transaction sending unit 1210 adds a header flag 31 to the transaction 30 to denote that the transaction 30 is the first reissued transaction and communicates the first reissued transaction to the I/O transaction processing unit 1120. The operation and function of the I/O transaction sending unit 1210 also preferably conforms to the I/O transaction sending unit described above.

The operation of the entire system will now be described by comparing it with that in the above embodiment. At first, a description will be made of a method for assuring the completion order of transactions when the transaction Tb is requested to be retried while a series of transactions Ta to Tc are issued consecutively.

Transactions Ta to Tc are issued from a device on an I/O bus 1021a to the node controller units 1001a and 1001b. At this time, the I/O transaction sending unit 1210 sets a ‘1’ in the header flag field corresponding to the Ta transaction 30 as shown in FIG. 2, since the transaction Ta is the first transaction among the series of transactions Ta to Tc.

Next, a description will be made for how each unit works for a received transaction. The network 1003 transfers each transaction received from the I/O unit 1002a to the node controller units 1001a and 1001b. The reply counting unit 1500 records the number of node controller units 1001a and 1001b (two in this case) to which each transaction is transferred.

The node controller unit 1001a replies “retry” to the network 1003, since the processor bus interface 1011 cannot process the transaction Tb. Receiving replies to the transactions from the node controller units 1001a and 1001b, the reply counting unit 1500 requests retry to the source I/O unit 1002a. At the same time, the reply counting unit 1500 communicates the retried transaction to the I/O transaction processing unit 1110. The I/O transaction processing unit 1110 then sets a ‘1’ in the corresponding retry bit in the retry control register 1400.

The node controller units 1001a and 1001b return “ok” to the network 1003 respectively, since they can process the transaction Tc. The reply counting unit 1500 counts the replies and communicates “ok” to the I/O transaction processing unit 1110. The I/O transaction processing unit 1110 then refers to the retry control register 1400 corresponding to the source I/O bus 1021a. Because a ‘1’ is set in the retry bit, the I/O transaction processing unit 1110 knows that the preceding transaction has been retried. Consequently, the I/O transaction processing unit 1110 also requests retry of the Tc so as to assure the completion order of transactions.

The source node I/O unit 1002a reissues the retry-requested Tb and Tc transactions and sets a ‘1’ in the header flag field 31 of the Tb transaction, which is reissued first.

The I/O transaction processing unit 1110 knows that the Tb transaction is the reissued first transaction since a header flag is added to the received Tb and a ‘1’ is set in the corresponding retry bit in the retry control register 1400. As a result, the I/O transaction processing unit 1110 clears the corresponding retry bit in the retry control register 1400 to a ‘0’ and restarts the processing of the Tb and Tc transactions.

With the above processing method, the successive transactions can be retried when a retry of the transactions issued from the I/O bus 1021a is requested, whereby the completion order of transactions can be assured.

Next, a description will be made for the operation of each unit when a reply to a transaction is suspended. At first, a description will be made for a method for assuring the completion order of transactions, for example, when the reply to the transaction Tb is suspended.

Receiving the transaction Tb, the node controller unit 1001a, when being enabled to return the reply to the Tb immediately, communicates the reply pending to the network 1003. The reply counting unit 1500 then communications the reply pending for the Tb to the I/O transaction processing unit 1110. The I/O transaction processing unit 1110 then sets a ‘1’ in the pending bit corresponding to the source I/O bus in the reply pending control register 1410 of the I/O flag register 1120 and the node controller unit 1001a waits for the reply to the Tb.

The reply counting unit 1500, when receiving replies to the Tc from the node controller units 1001a and 1001b, counts the replies and communicates OK to the I/O transaction processing unit 1110. The I/O transaction processing unit 1110 then knows that the reply to the preceding transaction is still suspended, since a ‘1’ is set in the corresponding pending bit of the reply pending control register 1410. The I/O transaction processing unit 1110 thus sets a ‘1’ in the corresponding retry bit in the retry control register 1400 to request retry of the Tc and assure the completion order of transactions.

Receiving the reply to the Tb from the node controller unit 1001a, the reply counting unit 1500 returns the reply to the Tb (“ok” in this case) to the source I/O unit 1002a. At the same time, the reply counting unit 1500 communicates the received reply to the Tb to the I/O transaction processing unit 1110. The I/O transaction processing unit 1110 then clears the corresponding pending bit in the reply pending control register 1410 to a ‘0’, since the Tb is the first transaction to which the reply has been suspended. With the above processing method, the completion order of transactions can be assured even when replies to a series of transactions are suspended respectively at a middle point.

With the above processing, when a transaction from an I/O bus is retried or even when the reply to the transaction is suspended before it is retried, the successive transactions can be retried. The completion order of transactions can thus be assured.

[Variations of the Second Exemplary Embodiment]

The second embodiment can also be varied in the same way as the variations to the first exemplary embodiment.

As described above, according to the present invention, it is possible to improve the throughput of the entire system, since successive transactions can be issued consecutively without waiting for completion of the preceding transaction. It may also be possible to issue transactions consecutively while the completion of transactions is assured even when a reply side device suspends the reply to a transaction.

The foregoing invention has been described in terms of preferred embodiments. However, those skilled, in the art will recognize that many variations of such embodiments exist. Such variations are intended to be within the scope of the present invention and the appended claims.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

What is claimed is:

1. A processor system, comprising:
at least one processor;
a node controller unit connected to said at least one processor via a processor bus;
at least one I/O unit having an I/O bus;
at least one memory, and
a network connecting each of said memories, said node controller unit, and each of said I/O units;
wherein each of said I/O units is adapted to consecutively issue a successive transaction to any of said memories or any of said processors before a preceding transaction has been processed;
further wherein said node controller unit, when said memory or said processor retries and suspends the reply to said preceding transaction issued from said I/O bus, causes said I/O unit to suspend the reply to said successive transaction or request the retry of and reissue said successive transaction.

2. The processor system according to claim 1, wherein said node controller unit is further comprised of:
a retry control register having retry bits corresponding to the number of said I/O buses and being adapted to record a reply of a preceding transaction issued from said I/O bus; and
a reply pending control register having reply pending bits corresponding to the number of said I/O buses and being adapted to record a suspension of the reply to said preceding transaction issued from said I/O bus.

3. A processor system, comprising:
at least one processor;
a node controller unit connected to said at least one processor via a processor bus;
at least one I/O unit having an I/O bus;
at least one memory, and
a network connecting each of said memories, said node controller unit, and each of said I/O units;
wherein each of said I/O units is adapted to consecutively issue a successive transaction to any of said memories or any of said processors before a preceding transaction has been processed;
further wherein a transfer unit in said network, when said memory or said processor retries said preceding transaction issued from said I/O bus, causes said I/O unit to request the retry of and reissue said successive transaction, said transfer unit not being located in said node controller unit.

4. The processor system according to claim 3, wherein said transfer unit further comprises a retry control register having retry bits corresponding to the number of said I/O buses and being adapted to record the number of retries of said preceding transaction issued from said I/O bus.

5. The processor system according to claim 4, wherein said transfer unit further comprises a reply pending control register having pending bits corresponding to the number of said I/O buses and being adapted to record a pending of the reply of the preceding transaction issued from said I/O bus.

6. The processor system according to claim 2, wherein said node controller unit is adapted to set a corresponding retry bit in said retry control register when retrying a write transaction issued from said I/O unit and to cause the successive transaction to be retried when said retry bit is set, further wherein said I/O unit comprises a transaction sending queue for sequentially storing transactions issued from said I/O bus, wherein said transaction sending queue includes a transaction attribute field for determining whether said transaction is a retried one, and further wherein said I/O unit is adapted to consecutively issue transactions queued in said transaction sending queue and to reissue retry-requested transactions.

7. The processor system according to claim 4, wherein said transfer unit is adapted to set a corresponding retry bit in said retry control register when retrying a write transaction issued from said I/O unit and to cause the successive transaction to be retried when said retry bit is set, further wherein said I/O unit comprises a transaction sending queue for sequentially storing transactions issued from said I/O bus, wherein said transaction sending queue includes a transaction attribute field for determining whether said transaction is a retried one, and further wherein said I/O unit is adapted to consecutively issue transactions queued in said transaction sending queue and to reissue retry-requested transactions.

8. The processor system according to claim 6, wherein said I/O unit is adapted to add a header flag to the first transaction in said transaction queue to distinguish it from other transactions in the queue when transactions are issued or reissued consecutively, and wherein said node controller unit is adapted to clear a retry bit in said retry control register corresponding to said I/O bus when receiving said first transaction.

9. The processor system according to claim 7, wherein said I/O unit is adapted to add a header flag to the first transaction in said transaction queue to distinguish it from other transactions in the queue when transactions are issued or reissued consecutively, and wherein said transfer unit is adapted to clear a retry bit in said retry control register corresponding to said I/O bus when receiving said first transaction.

10. The processor system according to claim 6, wherein said I/O unit is adapted to add an ID to each transaction when said transaction is issued; and wherein said node controller unit further comprises a transaction ID field and is adapted to record the ID of a retry-requested write transaction in said transaction ID field, to refer to said transaction ID recorded in said retry control register when accepting said write transaction reissued from said I/O unit, and to clear the retry bit in the reply control register corresponding to said write transaction when the ID of said write transaction matches said recorded ID.

11. The processor system according to claim 7, wherein said I/O unit is adapted to add an ID to each transaction when said transaction is issued; and wherein said transfer unit further comprises a transaction ID field and is adapted to record the ID of a retry-requested write transaction in said transaction ID field, to refer to said transaction ID recorded in said retry control register when accepting said write transaction reissued from said I/O unit, and to clear the retry bit in the reply control register corresponding to said write transaction when the ID of said write transaction matches said recorded ID.

12. The processor system according to claim 6, wherein said I/O unit further comprises a retry counter for storing the number of reissued and retried transactions; wherein said I/O unit is adapted to add said stored number to each of the consecutively issued transactions and increment said retry counter each time a transaction is reissued; wherein said node controller unit further comprises a retry counter field for recording the value of said transaction retry counter and is adapted to record the retry count of a write transaction in said retry counter field, to refer to said retry counter field when accepting a transaction issued from said I/O unit, and to clear the retry bit in the reply control register corresponding to said accepted transaction when said recorded retry count differs from that of said transaction retry counter.

13. The processor system according to claim 7, wherein said I/O unit further comprises a retry counter for storing the number of reissued and retried transactions; wherein said I/O unit is adapted to add said stored number to each of the consecutively issued transactions and increment said retry counter each time a transaction is reissued; wherein said transfer unit further comprises a retry counter field for recording the value of said transaction retry counter and is adapted to record the retry count of a write transaction in said retry counter field, to refer to said retry counter field when accepting a transaction issued from said I/O unit, and to clear the retry bit in the reply control register corresponding to said accepted transaction when said recorded retry count differs from that of said transaction retry counter.

14. The processor system according to claim 2, wherein said node controller unit is adapted to suspend a reply to a received preceding transaction and reply to a successive transaction arriving earlier than said preceding transaction to which the reply is to be suspended.

15. The processor system according to claim 5, wherein said transfer unit is adapted to suspend a reply to a received preceding transaction and reply to a successive transaction arriving earlier than said preceding transaction to which the reply is to be suspended.

16. The processor system according to claim 14, wherein said system is adapted to set a pending bit corresponding to the I/O bus in said reply pending control register when a retry to a transaction is suspended.

17. The processor system according to claim 15, wherein said system is adapted to set a pending bit corresponding to the I/O bus in said reply pending control register when a retry to a transaction is suspended.

18. The processor system according to claim 16, wherein said node controller unit is adapted to retry a successive transaction issued from said I/O bus when a pending bit corresponding to said I/O bus in said retry pending control register is set, and to clear said pending bit when replying to said pending transaction.

19. The processor system according to claim 17, wherein said transfer unit is adapted to retry a successive transaction issued from said same I/O bus when a pending bit corresponding to said I/O bus in said retry pending control register is set, and to clear said pending bit when replying to said pending transaction.

20. The processor system according to claim 18, wherein said node controller unit is adapted to suspend a reply to a successive transaction when a pending bit corresponding to said I/O bus is set and to clear said pending bit when a retry bit corresponding to said I/O bus in said retry control register is cleared.

21. The processor system according to claim 19, wherein said transfer unit is adapted to suspend a reply to a successive transaction when a pending bit corresponding to said I/O bus is set and to clear said pending bit when a retry bit corresponding to said I/O bus in said retry control register is cleared.

22. The processor system according to claim 1, wherein said node controller unit further comprises a pending counter corresponding to said I/O bus in said reply pending control register, wherein said node controller unit is adapted to increment said pending counter when suspending a reply to a transaction issued from said I/O unit, to suspend the reply to said transaction when accepting a successive transaction issued from said I/O unit while the value of said corresponding pending counter is at least one, and to decreasing the value of said pending counter when replying to said reply-pending transaction.

23. The processor system according to claim 3, wherein said transfer unit further comprises a pending counter corresponding to said I/O bus in said reply pending control register, wherein said node controller unit is adapted to increment said pending counter when suspending a reply to a transaction issued from said I/O unit, to suspend the reply to said transaction when accepting a successive transaction issued from said I/O unit while the value of said corresponding pending counter is at least one, and to decreasing the value of said pending counter when replying to said reply-pending transaction.

24. The processor system according to claim 20, wherein said node controller unit further comprises reply pending ID fields corresponding to the number of said I/O buses in said reply pending control register; wherein said node controller unit is adapted to record the ID of a transaction in its corresponding reply pending ID field when suspending a reply to said transaction issued from said I/O unit, to refer to the corresponding reply pending ID field when replying to a transaction to which a reply is suspended, and to clear the pending bit corresponding to the transaction when detecting that the ID of said transaction matches with said ID set in said reply pending ID field.

25. The processor system according to claim 21, wherein said transfer unit further comprises reply pending ID fields corresponding to the number of said I/O buses in said reply pending control register; wherein said node controller unit is adapted to record the ID of a transaction in its corresponding reply pending ID field when suspending a reply to said transaction issued from said I/O unit, to refer to the corresponding reply pending ID field when replying to a transaction to which a reply is suspended, and to clear the pending bit corresponding to the transaction when detecting that the ID of said transaction matches with said ID set in said reply pending ID field.

26. The processor system according to claim 14, wherein said node controller unit further comprises I/O request queues corresponding to the number of said I/O buses; wherein said node controller unit is adapted to store transactions issued from said I/O unit in the corresponding I/O request queue in the order in which the transactions are accepted and to suspend a reply to a transaction issued from said I/O unit in the case where said transaction is not the first entry to the corresponding I/O request queue.

27. The processor system according to claim 15, wherein said transfer unit further comprises I/O request queues corresponding to the number of said I/O buses; wherein said node controller unit is adapted to store transactions issued from said I/O unit in the corresponding I/O request queue in the order in which the transactions are accepted and to suspend a reply to a transaction issued from said I/O unit in the case where said transaction is not the first entry to the corresponding I/O request queue.
